(19) United States
(12) Patent Application Publication
(10) Pub. No.: US 2024/0198897 A1
(43) Pub. Date: Jun. 20, 2024

(54) License Plate Lighting Assembly

(71) Applicant: Cuney Crenshaw, Giddings, TX (US)

(72) Inventor: Cuney Crenshaw, Giddings, TX (US)

(21) Appl. No.: 18/085,029

(22) Filed: Dec. 20, 2022

(51) Int. Cl. B60Q 1/56; B60R 13/10; B60R 16/033

(52) U.S. Cl. CPC B60Q 1/56; B60R 13/105; B60R 16/033

(57) ABSTRACT

A license plate lighting assembly for enhancing visibility of a license plate includes a frame is mountable around a license plate on a vehicle. The frame is comprised of a translucent material to pass light through the frame. A plurality of light emitters is each integrated into the frame and each of the light emitters emits light outwardly through the frame when the light emitters are turned on to illuminate the license plate. Each of the light emitters is in remote communication with a personal electronic device thereby facilitating the personal electronic device to remotely control the plurality of light emitters.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lighting devices and more particularly pertains to a new lighting device for enhancing visibility of a license plate. The device includes a translucent frame that is positionable around a license plate and a plurality of light emitters integrated into the frame. The device includes a transceiver that is in wireless communication with a personal electronic device for remotely controlling the light emitters.

### (2) Description of Related Art Including Information Disclosed Under 37 CFR 1.97 and 1.98

The prior art relates to lighting devices including a variety of license plate frames that each at least includes a plurality of light emitters each integrated into a translucent frame for illuminating a license plate. The prior art discloses a plurality of modular license plate devices that at least includes a plurality of panels that are assembled together to define a license plate frame. The prior art discloses a license plate holder that includes a frame and an articulated arm for positioning the frame at a variety of orientations.

### BRIEF SUMMARY OF THE INVENTION

An embodiment of the disclosure meets the needs presented above by generally comprising a frame is mountable around a license plate on a vehicle. The frame is comprised of a translucent material to pass light through the frame. A plurality of light emitters is each integrated into the frame and each of the light emitters emits light outwardly through the frame when the light emitters are turned on to illuminate the license plate. Each of the light emitters is in remote communication with a personal electronic device thereby facilitating the personal electronic device to remotely control the plurality of light emitters.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front phantom view of a license plate lighting assembly according to an embodiment of the disclosure.

FIG. 2 is a front perspective view of an embodiment of the disclosure.

FIG. 3 is a perspective in-use view of an embodiment of the disclosure.

FIG. 4 is a schematic view of an embodiment of the disclosure.

### DETAILED DESCRIPTION OF THE INVENTION

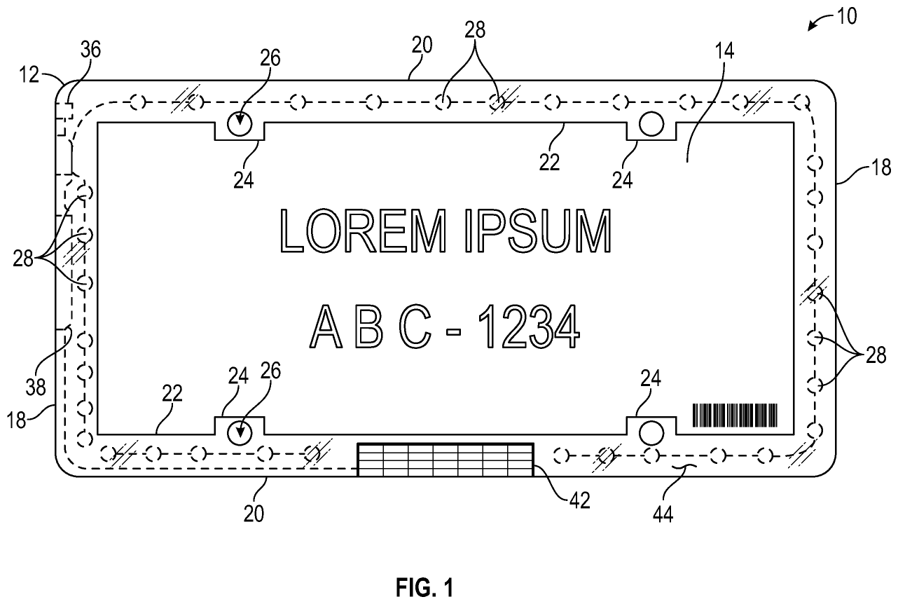

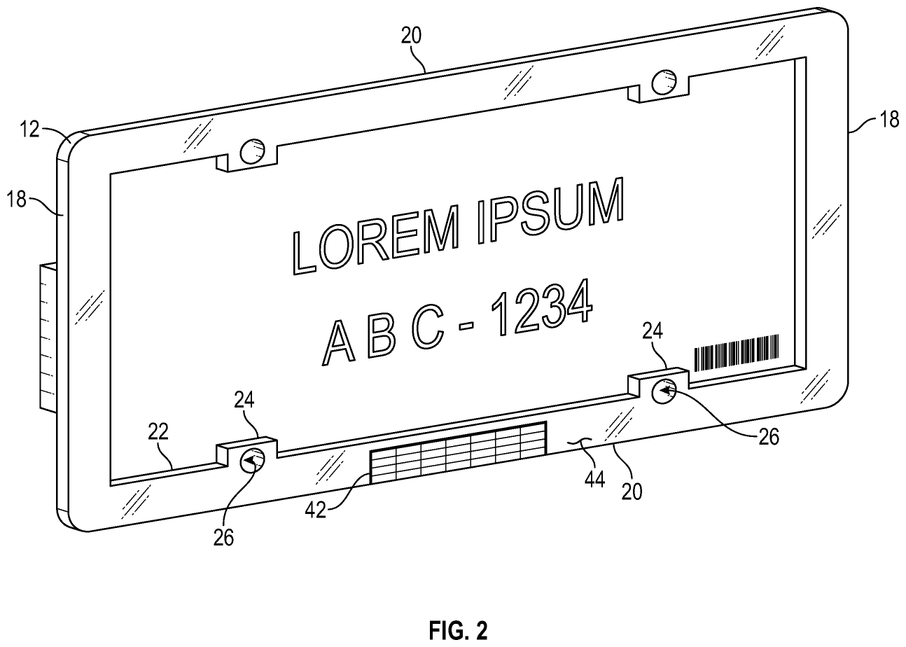

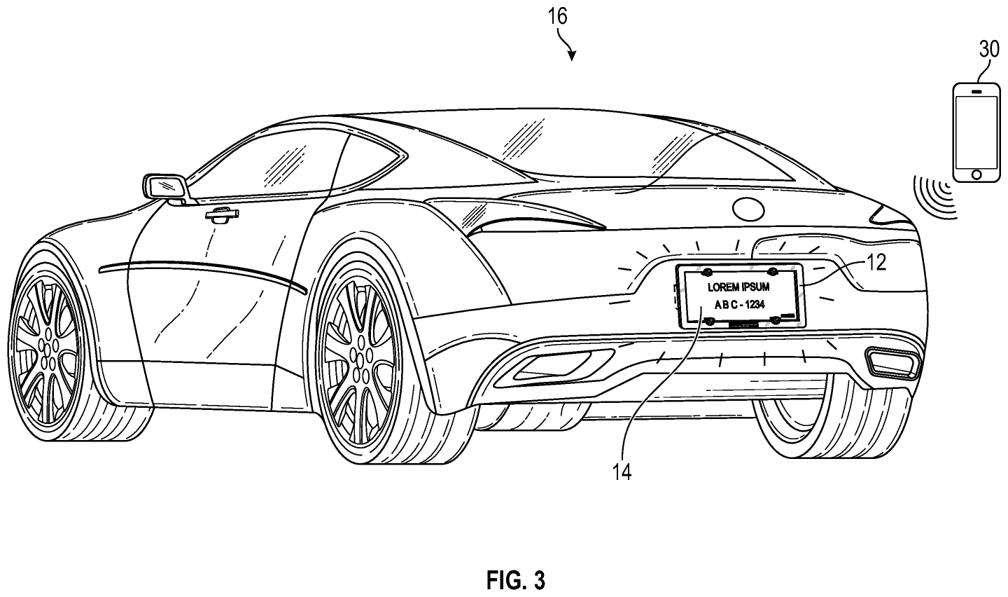

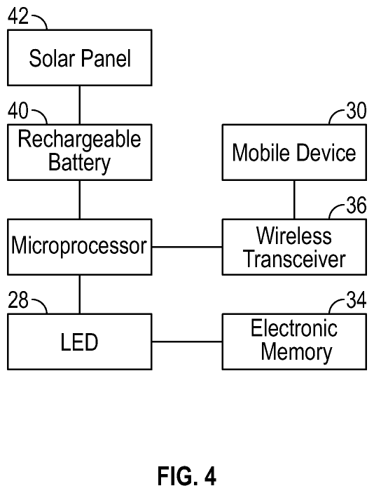

With reference now to the drawings, and in particular to FIGS. 1 through 4 thereof, a new lighting device embodying the principles and concepts of an embodiment of the disclosure and generally designated by the reference numeral 10 will be described.

As best illustrated in FIGS. 1 through 4, the license plate lighting assembly 10 generally comprises a frame 12 that is mountable around a license plate 14 on a vehicle 16. The vehicle 16 may be a motorized vehicle, such as a passenger vehicle for example, that is driven on public roadways and the license plate 14 may be a rear license plate of the vehicle 16. The frame 12 is comprised of a translucent material, including but not being limited to plastic or glass, to pass light through the frame 12. The frame 12 comprises a pair of first members 18 that each extends between a pair of second members 20 and each of the first members 18 is perpendicularly oriented with the second members 20. Additionally, each of the second members 20 has a length that is greater than a length of the first members 18 such that the frame 12 has a rectangular shape.

Each of the second members 20 has an inwardly facing edge 22 and each of the second members 20 has a pair of tabs 24 extending away from the inwardly facing edge 22. The tabs 24 on each of the second members 20 are spaced from a respective one of the first members 18. The frame 12 has a plurality of mounting holes 26 each extending through a respective one of the tabs 24. Each of the mounting holes 26 extends along an axis that is perpendicularly oriented with the second members 20 to accommodate a fastener for attaching the frame 12 to the vehicle 16.

A plurality of light emitters 28 is integrated into the frame 12 and each of the light emitters 28 emits light outwardly through the frame 12 when the light emitters 28 are turned on to illuminate the license plate 14. Additionally, the light emitters 28 enhance visibility of the vehicle 16 during nighttime driving to reduce the likelihood of a rear end collision. The light emitters 28 are spaced apart from each other and are distributed along each of the second members 20 and each of the first members 18. Each of the light emitters 28 is in remote communication with a personal electronic device 30 thereby facilitating the personal electronic device 30 to remotely control the plurality of light emitters 28.

A control circuit 32 is integrated into the frame 12 and the control circuit 32 is electrically coupled to the plurality of light emitters 28. The control circuit 32 includes an electronic memory 34 which stores a plurality of operational programs for the light emitters 28 thereby facilitating the plurality of light emitters 28 to emit various colors of lights and to be actuated according to one of a variety of pre-determined patterns. Each of the light emitters 28 may comprise a light emitting diode or other type of electronic light emitter. A transceiver 36 is integrated into the frame 12 and the transceiver 36 is electrically coupled to the control circuit 32. The transceiver 36 is in wireless communication with the personal electronic device 30 and the transceiver 36 downloads operational commands received from the personal electronic device 30 into the control circuit 32 thereby facilitating the personal electronic device 30 to remotely control the light emitters 28. The transceiver 36 may comprise a radio frequency transceiver or the like and the transceiver 36 may employ Bluetooth communication protocols. Additionally, the personal electronic device 30 may comprise a smart phone or other similar type of device.

A power supply 38 is integrated into the frame 12 and the power supply 38 is electrically coupled to the control circuit 32. The power supply 38 comprises a rechargeable battery 40 that is integrated into the frame 12 and the rechargeable battery 40 is electrically coupled to the control circuit 32. The power supply 38 includes a solar panel 42 that is coupled to the frame 12 such that the solar panel 42 is exposed to sunlight when the vehicle 16 is outside. The solar panel 42 is electrically coupled to the rechargeable battery 40 for charging the rechargeable battery 40. Additionally, the solar panel 42 is positioned on an outwardly facing surface 44 of a respective one of the second members 20 of the frame 12 and the solar panel 42 is centrally positioned between the pair of first members 18.

In use, the frame 12 is mounted to surround the license plate 14 and the personal electronic device 30 is synched with the transceiver 36. In this way the light emitters 28 can be remotely controlled with the personal electronic device 30. Furthermore, various patterns of flashing on and off along with various colors of light being emitted can be programmed into the control circuit 32 with the personal electronic device 30. In this way the appearance of the frame 12 and the light emitters 28 can be modified and customized to a user's preferences. Additionally, the light emitters 28 enhance visibility of the vehicle 16 during nighttime hours to reduce collisions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A license plate lighting assembly for illuminating a license plate on a vehicle, said assembly comprising:
a frame being mountable around a license plate on a vehicle, said frame being comprised of a translucent material wherein said frame is configured to pass light through said frame; and
a plurality of light emitters, each of said light emitters being integrated into said frame, each of said light emitters emitting light outwardly through said frame when said light emitters are turned on wherein said plurality of light emitters is configured to illuminate the license plate, each of said light emitters being in remote communication with a personal electronic device thereby facilitating said personal electronic device to remotely control said plurality of light emitters.

2. The assembly according to claim 1, wherein:
said frame comprises a pair of first members each extending between a pair of second members, each of said first members being perpendicularly oriented with said second members, each of said second members having a length being greater than a length of said first members such that said frame has a rectangular shape, each of said second members having an inwardly facing edge;
each of said second members has a pair of tabs extending away from said inwardly facing edge, said tabs on each of said second members being spaced from a respective one of said first members; and
said frame has a plurality of mounting holes each extending through a respective one of said tabs, each of said mounting holes extending along an axis being perpendicularly oriented with said second members wherein each of said mounting holes is configured to accommodate a fastener for attaching said frame to the vehicle.

3. The assembly according to claim 2, wherein said light emitters are spaced apart from each other and being distributed along each of said second members and each of said first members.

4. The assembly according to claim 1, further comprising a control circuit being integrated into said frame, said control circuit being electrically coupled to said plurality of light emitters, said control circuit including an electronic memory storing a plurality of operational programs for said light emitters thereby facilitating said plurality of light emitters to emit various colors of lights and to be actuated according to one of a variety of pre-determined patterns.

5. The assembly according to claim 5, further comprising a transceiver being integrated into said frame, said transceiver being electrically coupled to said control circuit, said transceiver being in wireless communication with said personal electronic device, said transceiver downloading operational commands received from said personal electronic device into said control circuit thereby facilitating said personal electronic device to remotely control said light emitters.

6. The assembly according to claim 5, wherein:
said frame has a pair of first members and a pair of second members; and
said assembly includes a power supply being integrated into said frame, said power supply being electrically coupled to said control circuit, said power supply comprising:
a rechargeable battery being integrated into said frame, said rechargeable battery being electrically coupled to said control circuit; and
a solar panel being coupled to said frame wherein said solar panel is configured to be exposed to sunlight when the vehicle is outside, said solar panel being electrically coupled to said rechargeable battery for charging said rechargeable battery, said solar panel being positioned on an outwardly facing surface of a respective one of said second members of said frame, said solar panel being centrally positioned between said pair of first members.

7. A license plate lighting assembly for illuminating a license plate on a vehicle, said assembly comprising:
a frame being mountable around a license plate on a vehicle, said frame being comprised of a translucent material wherein said frame is configured to pass light through said frame, said frame comprising a pair of first members each extending between a pair of second members, each of said first members being perpendicularly oriented with said second members, each of said second members having a length being greater than a length of said first members such that said frame has a rectangular shape, each of said second members having an inwardly facing edge, each of said second members having a pair of tabs extending away from said inwardly facing edge, said tabs on each of said second members being spaced from a respective one of said first members, said frame having a plurality of mounting holes each extending through a respective one of said tabs, each of said mounting holes extending along an axis being perpendicularly oriented with said second members wherein each of said mounting holes is configured to accommodate a fastener for attaching said frame to the vehicle;
a plurality of light emitters, each of said light emitters being integrated into said frame, each of said light emitters emitting light outwardly through said frame when said light emitters are turned on wherein said plurality of light emitters is configured to illuminate the license plate, said light emitters being spaced apart from each other and being distributed along each of said second members and each of said first members, each of said light emitters being in remote communication with a personal electronic device thereby facilitating said personal electronic device to remotely control said plurality of light emitters;
a control circuit being integrated into said frame, said control circuit being electrically coupled to said plurality of light emitters, said control circuit including an electronic memory storing a plurality of operational programs for said light emitters thereby facilitating said plurality of light emitters to emit various colors of lights and to be actuated according to one of a variety of pre-determined patterns;
a transceiver being integrated into said frame, said transceiver being electrically coupled to said control circuit, said transceiver being in wireless communication with said personal electronic device, said transceiver downloading operational commands received from said personal electronic device into said control circuit thereby facilitating said personal electronic device to remotely control said light emitters; and
a power supply being integrated into said frame, said power supply being electrically coupled to said control circuit, said power supply comprising:
a rechargeable battery being integrated into said frame, said rechargeable battery being electrically coupled to said control circuit; and
a solar panel being coupled to said frame wherein said solar panel is configured to be exposed to sunlight when the vehicle is outside, said solar panel being electrically coupled to said rechargeable battery for charging said rechargeable battery, said solar panel being positioned on an outwardly facing surface of a respective one of said second members of said frame, said solar panel being centrally positioned between said pair of first members.
